(19) United States
(12) Patent Application Publication
(10) Pub. No.: US 2019/0384221 A1
(43) Pub. Date: Dec. 19, 2019

(54) Electro-Holographic Light Field Detection System

(71) Applicant: The Charles Stark Draper Laboratory, Inc., Cambridge, MA (US)

(72) Inventors: Gregg E. Favalora, Bedford, MA (US); Juha-Pekka Laine, Boston, MA (US); Joseph J. Register, St. Petersburg, FL (US); Dennis M. Callahan, Jr., Wellesley, MA (US); Ian Ward Frank, Arlington, MA (US)

(21) Appl. No.: 16/439,351

(22) Filed: Jun. 12, 2019

Related U.S. Application Data
(60) Provisional application No. 62/684,262, filed on Jun. 13, 2018.

(51) Int. Cl. G03H 1/00; G02F 1/11; G03H 1/22; G02F 1/335

(52) U.S. Cl. CPC G03H 1/0005; G02F 1/11; G03H 2225/21; G02F 1/335; G03H 2001/0088; G03H 1/2294

(57) ABSTRACT

SAW modulators are used as components of diffractive imaging systems. Arrays of the modulators can be used to detect the light field from a scene. In specific applications, they can be used to provide matched filtering for object recognition.

### RELATED APPLICATIONS

This application claims the benefit under 35 USC 119(e) of U.S. Provisional Application No. 62/684,262, filed on Jun. 13, 2018, which is incorporated herein by reference in its entirety.

### BACKGROUND OF THE INVENTION

A class of three dimensional (3D) display architectures utilize surface acoustic wave (SAW) optical modulators. This class of devices provides controllable sub-holograms from which a light field can be constructed. Briefly, in a SAW optical modulator, a waveguide, patterned on an optical substrate, carries a time-varying diffracting region that is formed by index changes due to the substrate's piezoelectric effect under radio frequency (RF) excitation (e.g., at 300 MHz), as described, for example, in Onural et al., “New high-resolution display device for holographic three-dimensional video: principles and simulations,” Optical Engineering, vol. 33(3), pp. 835-44 (1994); Matteo et al., Collinear Guided Wave to Leaky Wave Acoustooptic Interactions in Proton-Exchanged LiNbO3 Waveguides, IEEE Trans. on Ultrasonics, Ferroelectrics, and Frequency Control, 47(1), 16-28 (January 2000); Smalley et al., Anisotropic leaky-mode modulator for holographic video displays, Nature, 498, 313-317 (20 Jun. 2013); U.S. Pat. App. Publ. US 2014/0300695, FULL-PARALLAX ACOUSTO-OPTIC/ELECTRO-OPTIC HOLOGRAPHIC VIDEO DISPLAY.

One type of SAW modulator is the guided-to-leaky-mode device fabricated using lithium niobate as described, for example, in Hinkov et al., Collinear Acoustooptical TM-TE Mode Conversion in Proton Exchanged Ti:LiNbO3 Waveguide Structures, J. Lightwave Tech., vol. 6(6), pp. 900-08 (1988); Smalley et al., Anisotropic leaky-mode modulator for holographic video displays, Nature, vol. 498, pp. 313-317 (2013); McLaughlin et al., Optimized guided-to-leaky-mode device for graphics processing unit controlled frequency division of color, Appl. Opt., vol. 54(12), pp. 3732-36 (2015); Qaderi et al., Leaky-mode waveguide modulators with high deflection angle for use in holographic video displays, Opt. Expr., vol. 24(18), pp. 20831-41 (2016); and Savidis et al., Progress in fabrication of waveguide spatial light modulators via femtosecond laser micromachining, Proc. of SPIE Vol. 10115, 2017. The surface acoustic wave interacts with input light to cause at least some of the light to change from a guided mode within the waveguide to a leaky mode that exits the waveguide.

### SUMMARY OF THE INVENTION

The present invention concerns the use of SAW modulators as components of diffractive imaging systems. Arrays of the modulators can be used to detect the light field from a scene. In specific applications, they can be used to provide matched filtering for object recognition.

In general, according to one aspect, the invention features an optical detection system. The system comprises acousto optic modulators that collect light from a scene arriving at different angles; and a detection system for detecting the light collected by the acousto optic modulators.

In embodiments, the acousto optic modulators are surface acoustic wave modulators, such as leaky mode surface acoustic wave modulators.

In one implementation, the acousto optic modulators are arranged in an electro-holographic light field detection device including an array, such as two-dimensional array, of the modulators.

In some cases, the system further includes matched filters.

A polarizer is useful for linearly polarizing light received by the acousto optic modulators. In some case, an illuminator illuminates the scene with narrow band light and/or it might be tunable to scan the scene with light of different colors.

In general, according to another aspect, the invention features an optical detection method. The method comprises collecting light from a scene arriving at different angles with acousto optic modulators and detecting the light collected by the acousto optic modulators.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic side view of a conventional SAW optical modulator (“SAW device”) functioning in projection mode;

FIG. 2 is a schematic side view of another SAW modulator having an angled end face functioning in projection mode;

FIG. 3 is a schematic side view of a conventional SAW optical modulator (“SAW device”) functioning in diffractive imaging mode according to the invention;

FIG. 4 is a schematic side view of another SAW modulator having an angled end face functioning in diffractive imaging mode according to the invention;

FIG. 5A is a side cross-sectional view showing an exemplary SAW modulator of a light field detection device according to the present invention;

FIG. 5B is a top view of a light field detection device showing its array of SAW modulators;

FIG. 6 is a schematic side view of another SAW modulator that receives light in through its proximal face;

FIG. 7 shows SAW modulators arranged in a stack as part of a light field detection system;

FIG. 8 shows SAW modulators arranged in a line as part of a light field detection system;

FIG. 9 is a schematic front view of a light field detection system or imaging system according to the present invention;

FIGS. 10A, 10B, and 10C are schematic diagrams illustrating one application for the electro-holographic light field detection system or imaging system;

FIG. 11 is a schematic diagram showing a holographic filter spread across an array of modulators in the imaging system;

FIGS. 12A and 12B are a schematic perspective view and a side view, respectively, of a line, stack or substrate of SAW modulators 910; and

FIG. 13A through 13E are plots of the received light amplitude as a function of SAW drive frequency for the respective modulators.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is to be understood that many materials and design choices are available to the engineer in implementing the teachings described herein, and all of them are subsumed within the scope of the present invention. Thus, while lithium niobate as a substrate material is discussed, for heuristic convenience, as a suitable material, a person of ordinary skill in the art will appreciate that various materials are available to the engineer, and that lithium niobate is merely exemplary, as are various crystal orientations, such as x-cut and y-cut, and waveguide architectures, such as planar, ridge, rib, embedded, immersed, and bulged. Methods described herein may be advantageously performed using waveguides in y-cut, x-propagating lithium niobate, due to its high efficiency of electrical to mechanical transduction. Doping, such as resulting in MgO-doped lithium niobate, may be employed advantageously, in some cases, to reduce photorefractive damage.

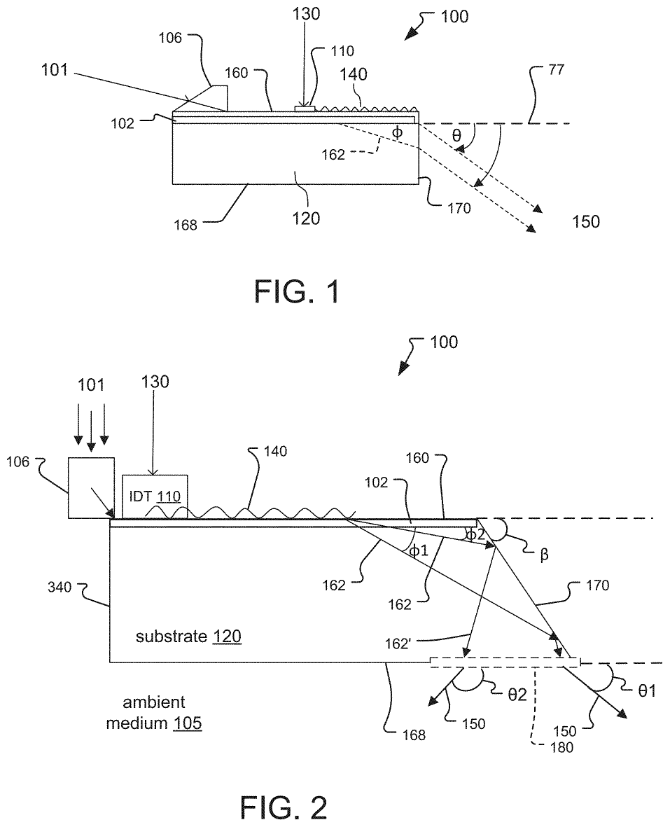

To understand the present invention, some background is helpful. To this end, FIG. 1 shows an exemplary, prior art, edge-fire, leaky-mode surface acoustic wave (SAW) modulator 100.

The modulator 100 comprises a substrate 120 in which or on which an acousto-optic waveguide 102 has been formed. The input light 101 at one or more wavelengths enters waveguide 102. Typically, an in-coupling device 106 is provided to couple the input light 101 carried in an optical fiber, for example, into the waveguide 102. Examples of in-coupling devices 106 include in-coupling prisms, gratings, or simply butt-coupling techniques between the optical fiber and the waveguide 102. The input light 101 is launched into a guided mode upon entry into the waveguide 102. Commonly, the TE (transverse electric) mode is guided.

In such a SAW modulator 100, the slab waveguide 102 is typically created in a lithium niobate substrate 120 by proton-exchange. Interdigital transducers 110 are deposited, e.g. using a photolithographic lift-off process on proximal face 160. The transducers might be “chrome gold,” a layer of chrome and a layer of gold. The transducers 110 induce surface acoustic waves (SAWs) 140 in the substrate 120 that propagate along the waveguide 102, with the light or contra directional to the light. Such transducers 110 are often driven electrically, e.g. using a 300-500 MHz radio frequency (RF) input signal 130.

The light interacts with the SAW 140. The result of this interaction between the SAW 140 and the light in the waveguide 102 is that a portion of the guided light is polarization-rotated out of the guided mode and into a leaky mode having the transverse magnetic (TM) polarization. The light then exits the waveguide 102 as polarized leaky-mode or diffracted light 162 and enters substrate 120 at a diffraction angle cp. At some point this diffracted light 162 exits the substrate 120, often through the substrate's end face 170 (as shown), distal face 168, or proximal face 160 as exit light 150 at an exit angle θ.

Depending on the crystal phase and the values of the overlap integral for the waveguide mode(s), using a higher or lower RF drive frequency of the RF input signals 130, a higher diffraction angle φ may be achieved. This range of possible diffraction angles φ and the corresponding exit angles θ, i.e., the exit fan, of the exit light 150 is generally limited due to fabrication, material, and power constraints.

FIG. 2 shows another SAW modulator 100 including an angled/reflective end face 170 and/or a transmissive optic 180 such as a grating on an exit face of the SAW device 100. This SAW modulator is a face-fire device since the light is leaving the distal face 168.

In more detail, input light 101 enters the substrate 120 via the in-coupling device 106 at the input end 340 and travels through the substrate 120 in one or more of the guided modes of the waveguide 102. When the surface acoustic waves 140 produced by the interdigital transducer 110 interact with the guided light, the light is diffracted and coupled into a leaky mode, which is no longer guided by the waveguide 102. The light of the leaky mode leaves the waveguide 102 and ultimately exits the substrate 120 as exit light 150.

The illustrated example uses a non-orthogonal end face 170. Specifically, in one example, the end face 170 is fabricated or machined (polished) at a non-right angle relative to the proximal face 160 and/or the distal face 168 of the substrate 120.

Further, the example also includes a transmissive optic 180, such as a diffractive optic or grating or refractive optic, within or upon an exit face, which is the distal face 168. The transmissive optic 180 might be patterned within/upon the exit faces during fabrication of the SAW modulator 100, in one example.

In more detail, the end face 170 of the substrate 120 is planar and angled by an edge cut angle β relative to the proximal face 160. The edge cut angle β is typically chosen such that a deflection of at least half of the available cone of the deflection angle φ, or φ/2, is normal or near normal to the distal, exit face 168 of the substrate 120 after the diffracted light 162 reflects off of the end face 170. Diffracted light 162 that reflects off of the end face 170, is referred to as reflected diffracted light 162′. The reflected diffracted light 162′ is then directed toward the transmissive optic 180, such as a grating. A reflective substance such as a metal coating or dielectric coating may be placed on the end face 170 to increase reflectivity and thus the intensity of the reflected diffracted light 162′ traveling toward the optic or grating 180. As the light 162′ interacts with the grating 180, the light might be dispersed, increasing the overall exit angle θ of the exit light 150.

SAW Modulator Imaging

The principle of Helmholtz reciprocity describes how a ray of light and its reverse ray encounter matched optical effects, such as reflections, refractions, and absorptions in a passive medium, or at an interface. As a result, incoming and outgoing light can be considered as reversals of each other without affecting the bidirectional reflectance distribution function (BRDF) outcome. As a result, generally a light sensor and light source can be swapped with each other in an optical system and the measurement of flux would nevertheless remain the same.

Applying this principle, the SAW modulators described above can be converted to diffractive imagers. The advantage being that they can detect an incoming light field since they can resolve both the magnitude and angle of the incoming rays from scene.

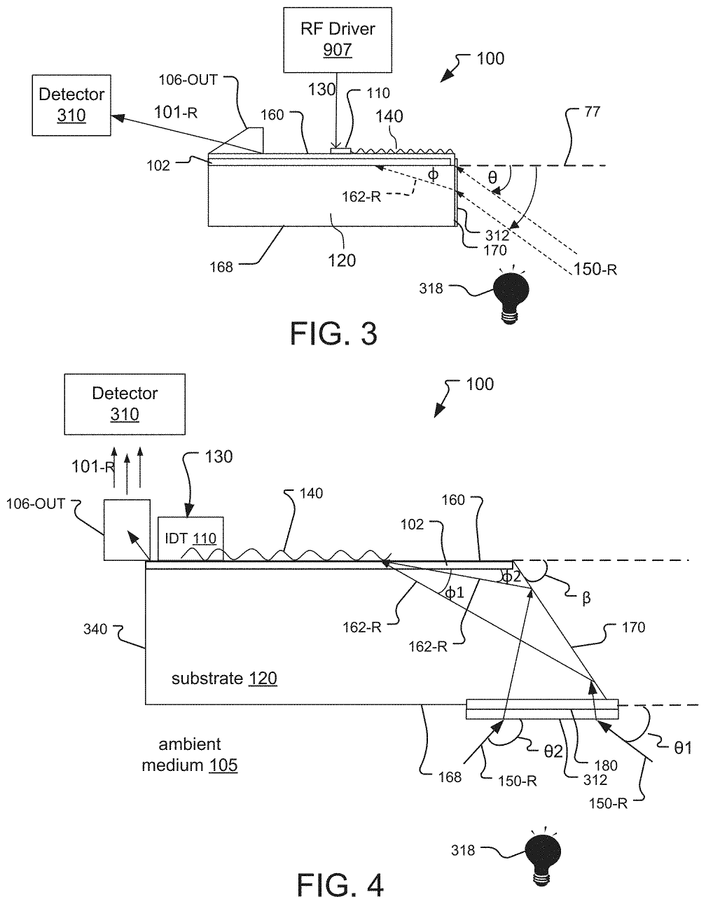

FIGS. 3 and 4 illustrate SAW modulators 100 operating in this diffractive imaging mode. Light from the scene 150-R is coupled through an entrance face, which is the end face 170 in the SAW optical modulator implementation of FIG. 3 or the distal face 168 of the embodiment shown in FIG. 4. The light is transmitted through the substrate 120 as incoming light 162-R. When light approaches at the proper angle to the waveguide 102, as dictated by the frequency of the SAW 140 and the wavelength of the light, the light is diffracted by the SAW 140 and excites one of the guided modes. By this effect, a portion of the light is coupled into the waveguide 102. It is then coupled out of the waveguide 102 by the out-coupling device 106-OUT and then detected by the detector 310.

In most embodiments, a front filter 312 is used. Minimally it should provide linear (TM) polarization. In some examples, the front filter 312 is also a spectral/bandpass filter, especially where the scene is being actively illuminated by a narrowband illuminator.

As a general rule, the light that is diffracted and coupled into the waveguide by a SAW of a given frequency will be light that is received at a specified angle and is of a specified wavelength. Thus, for example, if the scene or object of interest is illuminated by light within a narrow spectral band such as by a light emitting diode (LED) or laser illuminator 318, the SAW modulator 100 can resolve the incoming light field, within its acceptance angle fan θ, by scanning the frequency of the SAW and then correlating the response of the detector 310 to the instantaneous SAW frequency.

The illuminator 318 could be tunable to scan the scene with light of different colors.

Another option is to add spectral filtering to the filter 312 that allows light of only a specified wavelength band to be received by the SAW modulator, in the case of white light illumination of the scene. In one example, that wavelength passband of the filter 312 might be less than 10 nanometers (nm) wide such as 2 nm or less. In some embodiments, the filter 312 is tunable and is scanned through red, then green, then blue colors for the visible wavelengths, for example. In this way, an entire color light field can be detected.

Still another option is to use a spectrally resolving detector 310. This would allow the SAW modulator 100 to scan the entire color spectrum of the scene and then the detector 310 would detect the power in each of the wavelengths and then correlate those powers to the instantaneous frequency of the SAW 140.

Typically, the substrates 120 will have array of SAW modulators side-by-side in the direction orthogonal to the plane of the figures. As a result, each substrate might contain 10's or 100's of SAW modulators to thereby form a light field detection device.

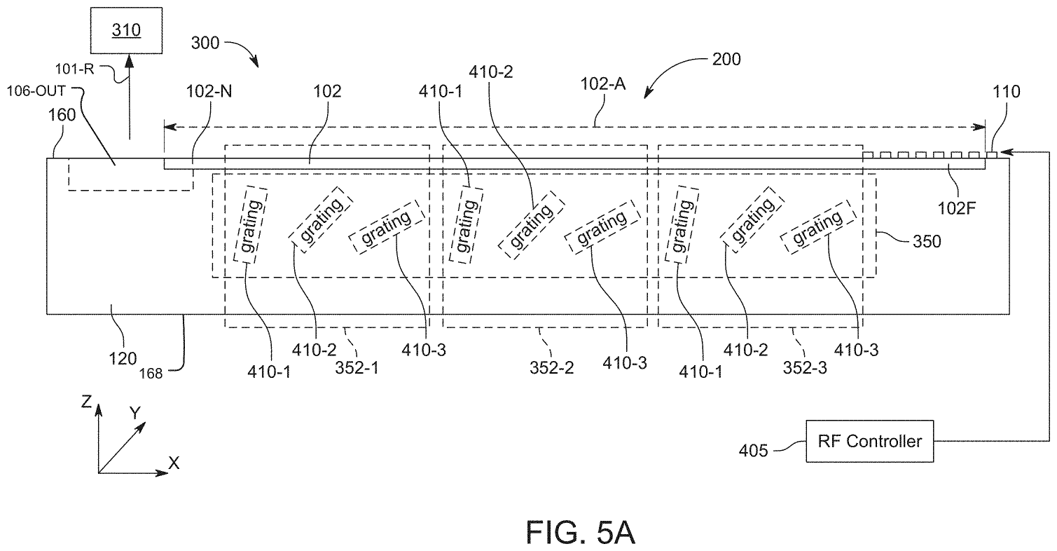

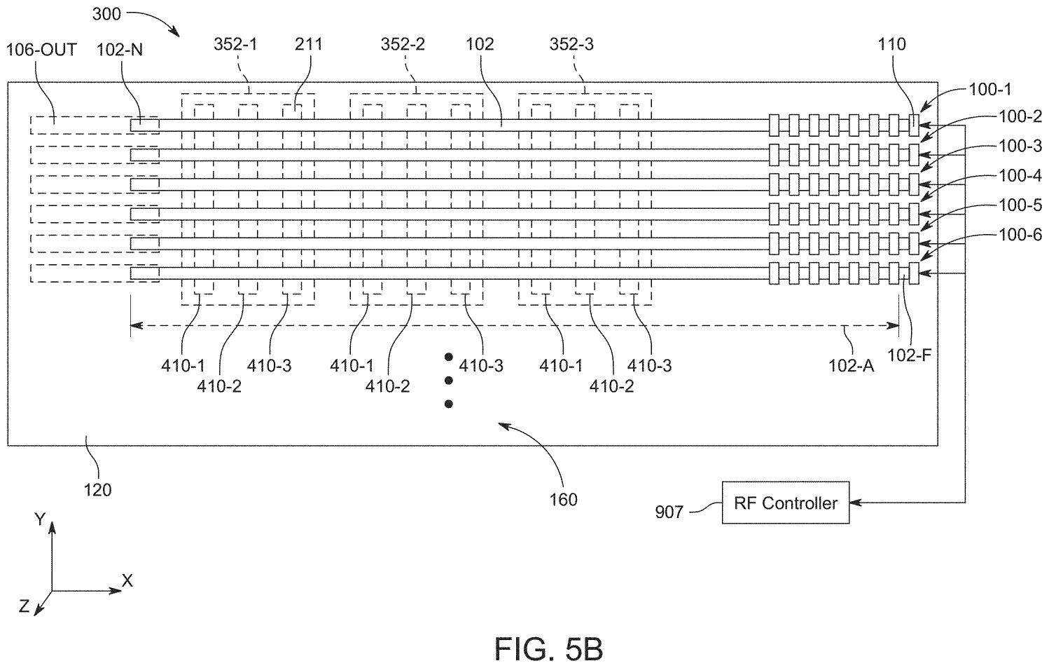

FIG. 5A shows a side cross-section showing the details of a SAW modulator and FIG. 5B shows a top view of electro-holographic light field detection device 300 integrating arrays of the SAW modulators of FIG. 5A, according to embodiments of the present invention. In this embodiment, light is received at multiple locations, pixels, along each waveguide 100 for light received through the proximal face 160 of the substrate 120.

The optical SAW substrate 120 has an array of SAW modulators 100-1 to 100-6. (In the illustrated embodiments, six explicit modulators 100 are shown. It should be noted, however, that in practice, especially for commercial devices, the substrate 120 will contain tens to hundreds, or more, of these modulators 100.) Each optical modulator 100 includes its waveguide 102 having opposing waveguide ends 102-N and 102-F, with respect to a longitudinal waveguide axis 102-A. At the near waveguide end 102-N, there is a light out-coupling device 106-OUT. At the far waveguide end 102-F, there is one or more surface acoustic wave (SAW) transducers (IDTs) 110. Ordinarily, the number of IDTs per waveguide is small: usually just 1, or maybe 2-5 if high bandwidth is needed, or if focusing or deflection in an unusual direction, such as with some y component are needed. A typical IDT has 50-100 fingers in it, about 1-2 micrometers wide per finger.

The coordinate axes in the figures define the x-axis as the propagation direction of light in the waveguides 102. The proximal face 160 of the substrate 120 is parallel to the x-y plane. The z-axis is perpendicular to the proximal face 160. (Note that the use of coordinate axes herein may differ from the tradition of naming the axes in lithium niobate wafers. References elsewhere, for example, to “x-cut, y-propagating” lithium niobate and the like may be in terms of axes that are defined in different directions than those in the present figures.)

As mentioned before, the optical substrate 120 may be made, for example, of a suitable piezoelectric material such as lithium niobate (LiNbO3), quartz (SiO₂), or lithium tantalate (LiTaO3) following known processes. These materials exhibit a birefringence property that allows for the convenient conversion of light into leaky modes and convenient polarization-based filtering of scattered light. Many other materials and design choices are available including other piezoelectric materials and crystallographic orientations, and waveguide architectures such as planar, ridge, rib, embedded, immersed, and bulged. Doping such as MgO-doped lithium niobate may be useful, in some cases. The optical substrate 120 may range in x- or y-dimensions of 1 centimeters (cm) (for near-eye display applications) to over 20 cm (for larger displays at larger viewing distances). Typically the thickness (z-dimension) of the optical substrate 120 ranges from 0.5 millimeters (mm) to 3 mm.

The light out-coupling device 106-OUT (e.g., an optical grating or prism) couples light 101-R in the waveguide 102 to a detector 310.

The SAW transducer 110 (e.g., an interdigital transducer (IDT)) is typically designed such that the SAW will propagate collinear with the waveguide 102, copropagating or counter propagating with the light. Further, the generation of the SAW is timed with the operation of the detector to enable resolution of source and direction of the light.

In different embodiments, the SAW transducers 110 can occupy a variety of specific locations and specific orientations with respect to their respective waveguide 102. In the illustrated embodiment, the SAW transducers 110 are located at the opposite, far end 102-F of the waveguides 102 from the out-coupling devices 106. Thus, the SAWs co-propagate, in a direction of the propagation of the light in the waveguides 102. In other examples, however, the SAW transducers 110 can be located proximate to the near end 102-N of the waveguide 102, near the out-coupling devices 106-OUT. Then, the SAWs will counter-propagate with the opposite direction of light propagation in the waveguides 102. Moreover, there could be multiple SAW transducers 110 for each waveguide 102, with each SAW transducer 110 responsible for a different specific bandwidth around a given center frequency (e.g., 100-200 MHz, 200-300 MHz, and 300-400 MHz).

For each optical modulator 100-1 to 100-6, there are multiple input couplers 410. In the illustrated embodiment, the input couplers 410 are distributed along the length of the waveguide 102. Specifically, the input couplers 410 are located within input coupling region 350, and divided into different pixel sets 352-1 to 352-3, to reflect the incoming light to be diffracted and thereby excite a mode or modes of the waveguide. The different input couplers 410 of each set provide different input angles at which light can be received. Specifically, the first pixel set 352-1 comprises three input couplers 410-1, 410-2, 410-3. Each of these three input couplers 410-1, 410-2, 410-3 is rotated around the y-axis to be angled at a different angle with respect to the x-axis such that they direct the incoming for a different range of angles with respect to the proximal face 160. The second pixel set 352-2 and the third pixel set 352-3 each comprise a similar set of three output couplers 410-1, 410-2, 410-3.

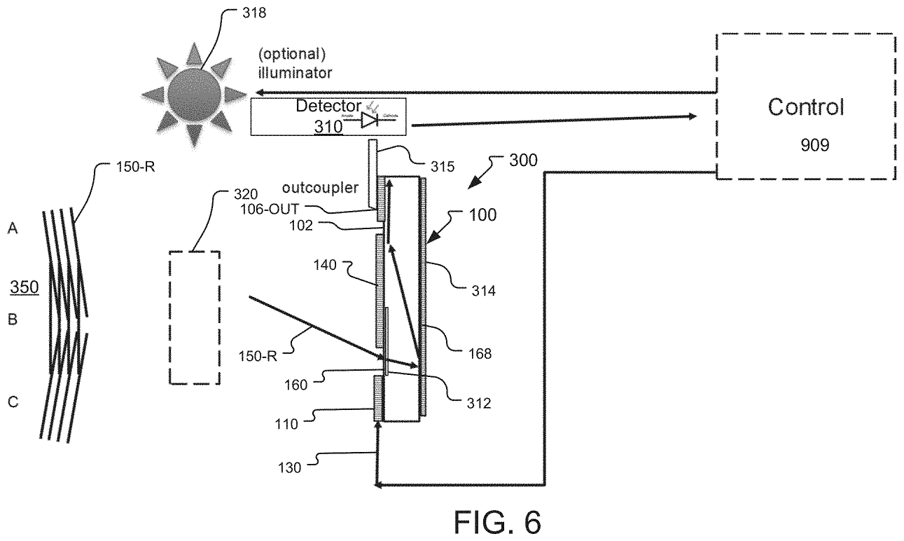

FIG. 6 shows another embodiment of an exemplary imaging-mode SAW modulator 100 of an electro-holographic light field detection device 300. Here, light from the scene 350 is coupled in through the proximal face 160. A reflective or light redirection layer 314 on the distal face 168 reflects or redirects the light so that it is coupled into the waveguide 102 by the SAW 140. The light redirection layer 314 is typically reflective grating, such as a subwavelength surface grating.

According to more details, the out coupler 106-OUT in the illustrated embodiment comprises a combination of a grating and an angle-polished optical fiber 315. This transmits the light to the detector 310.

In this embodiment, the illuminator 318 is used to illuminate the scene 350 with light of a known color. In another embodiment, the illuminator 318 illuminates the scene 350 at different wavelengths over time, under the control of the controller 909 so that a full color image of the scene can be built up by the controller 909.

Additional optics 320 are preferably added to each modulator 100. Specifically optics such as field-of-view expansion optics or a reversed telescope are used in a specific embodiments.

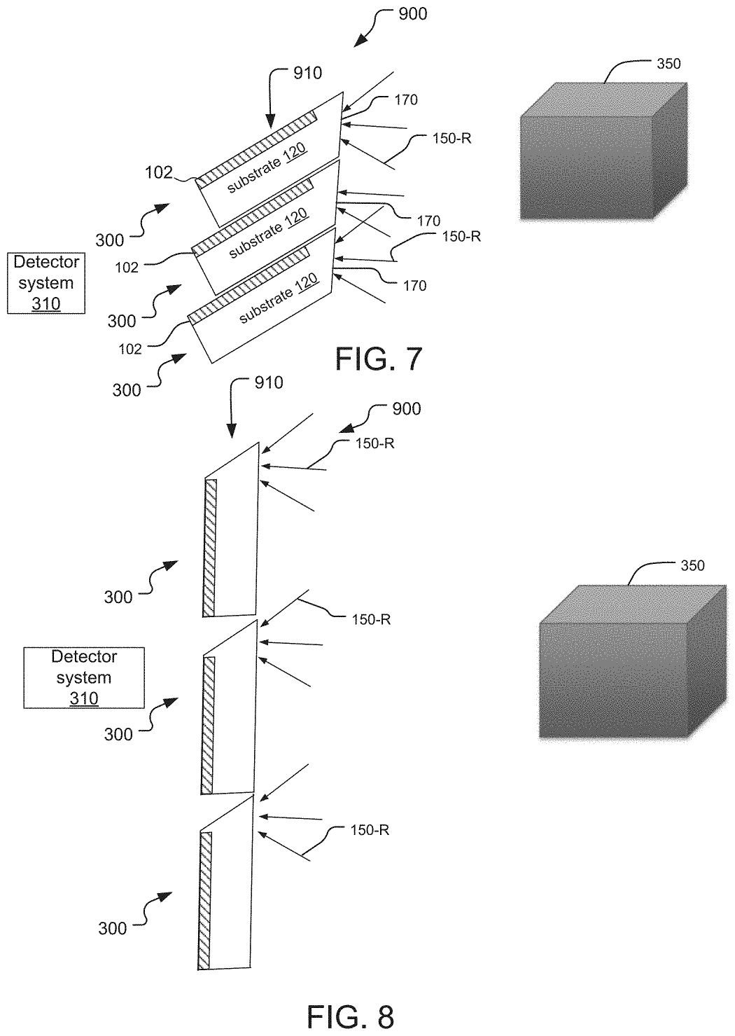

FIG. 7 shows electro-holographic light field detection devices 300 arranged in a stack 910 as part of a light field detection system, according to one embodiment.

In more detail, arrays of edge-fire SAW optical modulators 100 of each device 300 receive incoming light 150-R from the scene or object of interest. This light is collected at the angled end face 170 of each optical modulator 100 of a stack 910 of the device 300.

The electro-holographic light field detection devices 300 are arranged, one on top of the other, such that the distal faces 168 of the modulators 100 of each device 300 are adjacent to the proximal faces 160 of the modulators of the next device 300 in the stack 910.

The light from the electro-holographic light field detection devices 300 of the stack 910 is then provided to a detector system 310 that is able to detect the incoming light field from a line of the scene 350.

FIG. 8 shows electro-holographic light field detection devices 300 arranged next to each other in a line 910 to form an electro-holographic light field detection system 900, according to another embodiment.

This embodiment employs face-fire SAW optical modulators in each of electro-holographic light field detection devices 300. And, these optical modulators 100 utilize non-orthogonal end faces 170 in which the edge cut angles are acute or modulators according to the embodiment of FIG. 4 could also be used.

Still another option is to provide the SAW modulators, side-by-side, in a common substrate as described in U.S. Pat. No. 10,156,770, by Favalora, et al, which is incorporated herein by this reference. Such modulators might be edge-fire or face-fire as shown in FIG. 5 herein.

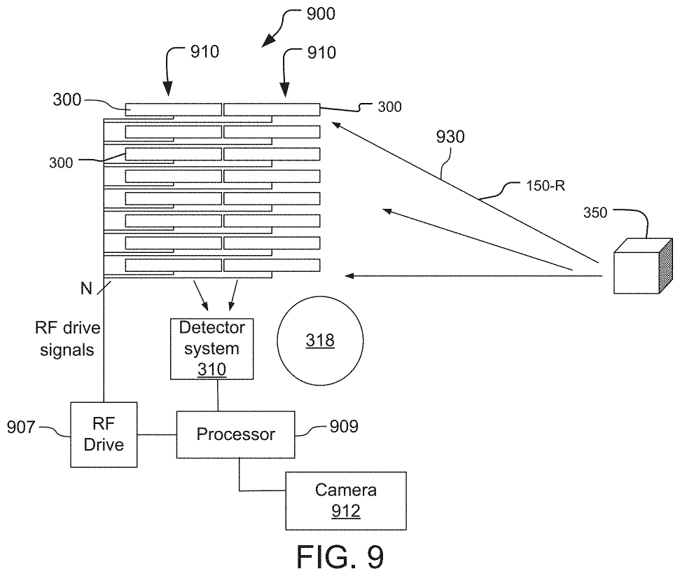

FIG. 9 shows a light field detection system or imaging system 900. Such a detection system 900 will typically include 100's or more lines or stacks 910 of devices 300, with 100's or more modulators 100 in each device, although only two stacks/lines and eight rows are shown in the illustrated example. Typically, the modulators 100 will be arranged in a two-dimensional array.

Further, a detector system 310 converts the detected light from each modulator 100 into frames of image data, enabling imaging of the 3D volume. Also included are an RF driver 907, and a processor controller 909.

Moreover, for 3D imaging systems, range determination can be added to each point in a scene. A structured light illuminator 318 projects a rainbow onto a scene and in possibly a known pattern. Then, simple triangulation can be employed to estimate distances. In a further detail, coarse and fine distance resolution is provided.

Still further, an ordinary visible-light camera 912 could be added. A structured-illumination rainbow system 318 would let the visible camera 912 and controller 909 estimate a rough distance measurement to scene points. Then this information is used by the controller 909 to select the SAW waveforms applied to the modulator array at a finer detail scale.

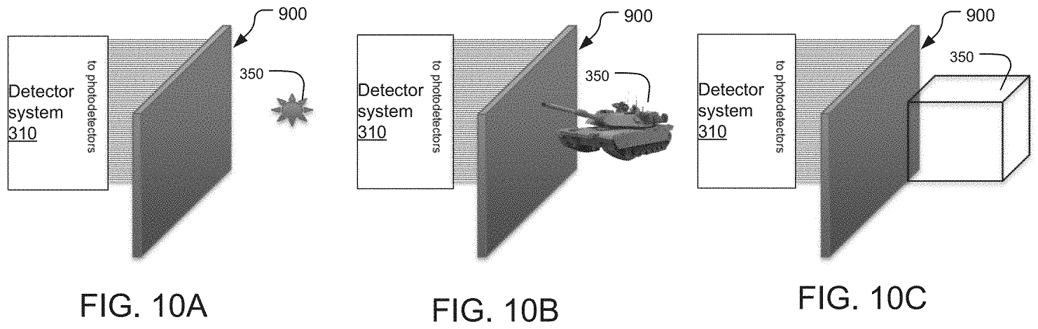

FIGS. 10A, 10B, and 10C illustrate one application for the electro-holographic light field detection system or imaging system 900.

In more detail, the imaging system 900 can be used as a matched filter to detect different objects of interest such as a point source shown in FIG. 10A or an object of interest such as a tank shown in FIG. 10B or an arbitrary object of interest as shown in FIG. 10C.

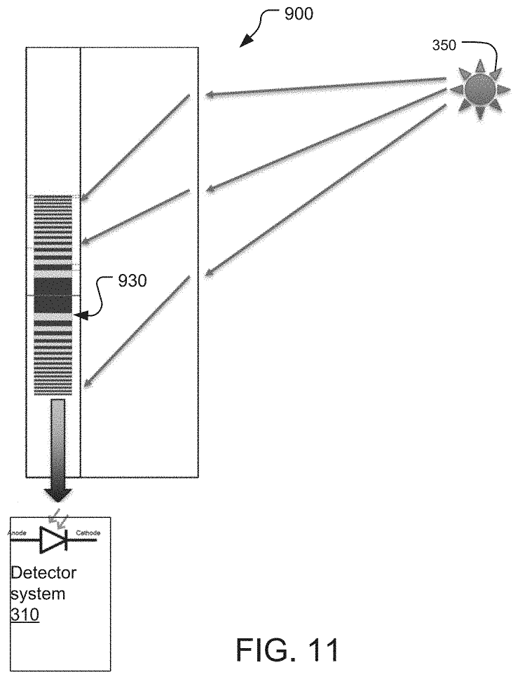

As shown in FIG. 11, in some embodiments, a holographic filter 930 is spread across a number of, such as, the entire array of modulators in the imaging system 900. Detectors such as avalanche photodiodes could be used in the detection system 310. The holographic filter 930 is representative of the object of interest in the scene 350. In this way, it would act as a matched filter.

In other examples, time varying holograms representative of scanned points or lines across imaged scene are used to cover the scene in an aggregate manner thus enabling the imaging of the total scene over some time interval. Examples of scanning modalities could be raster's point raster scanning, swept surface through the volume, multiple scan points or multiple scanned surfaces.

There are several families of computer generated display hologram (CGH) that can be illuminated to provide an image of a scene. In one case, the control applies sequences of holographic fringes that are matched filters not just for volume-occupying elements, but are responsive to their BDRF.

In implementations, the imaging system is used to image small features or objects, on the micron to centimeter scale.

Detection of a pattern on a surface and 3D face analysis are other uses for the imaging system 900.

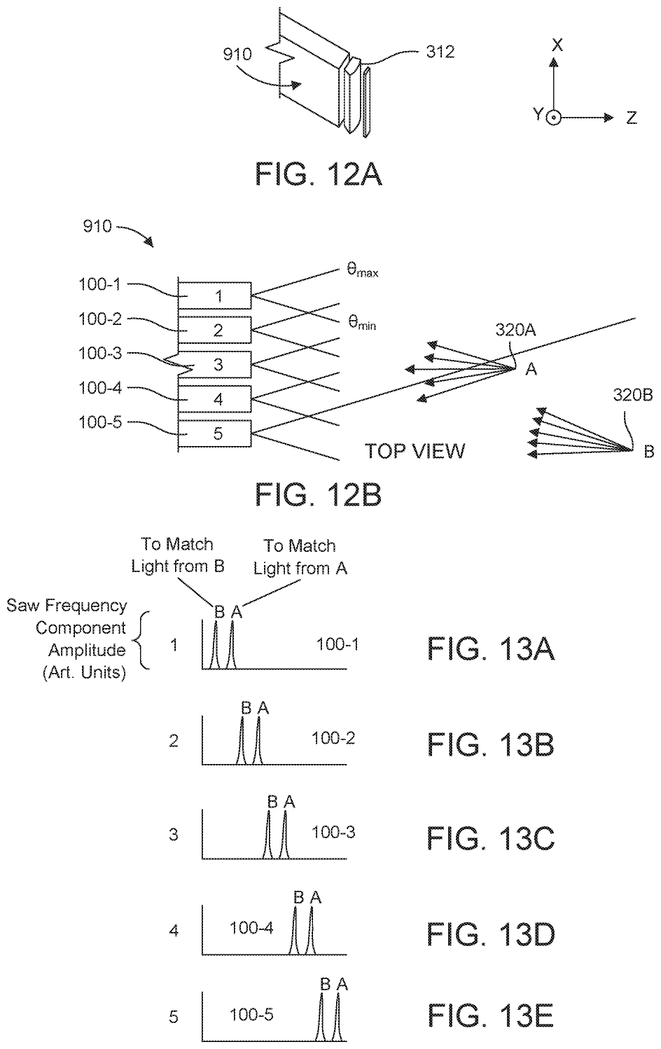

FIGS. 12A and 12B illustrate how a line, stack or substrate of SAW modulators 910 could be used to resolve the location of two points 320A, B in the scene.

In more detail, five SAW modulators 100-1 to 100-2 are contained in the line or stack 910. In still another embodiment, those SAW modulators could be formed in a common substrate 910, side-by-side, as provided in incorporated U.S. Pat. No. 10,156,770.

In one further example, several of these substrates and their modulators are butt-coupled to a spatially resolved two-dimensional CCD or CMOS, for example, camera detector array. This would enable high density/high resolution imaging system.

FIG. 12B shows a side view of the SAW modulators 100-1 to 100-5 and two points in the scene 320A, 320B. Each of the SAW modulators 100 has an associated entrance angle fan that stretches between θmax and 0 min. As a result, the light received at each of the modulators 100 from the points A, B is received at a slightly different angle with respect to that modulator.

FIGS. 13A through 13E show the received light amplitude as a function of SAW drive frequency for the respective modulators. Since the light is received at a different angle for each of the modulators 100-1 to 100-5, the plots show a response for different SAW drive frequencies.

While this invention has been particularly shown and described with references to preferred embodiments thereof, it will be understood by those skilled in the art that various changes in form and details may be made therein without departing from the scope of the invention encompassed by the appended claims.

What is claimed is:

1. An optical detection system, comprising:
acousto optic modulators that collect light from a scene arriving at different angles; and
a detection system for detecting the light collected by the acousto optic modulators.

2. The system as claimed in claim 1, wherein the acousto optic modulators are surface acoustic wave modulators.

3. The system as claimed in claim 1, wherein the acousto optic modulators are leaky mode surface acoustic wave modulators.

4. The system as claimed in claim 1, wherein the acousto optic modulators are arranged in an electro-holographic light field detection device including an array of the modulators.

5. The system according to claim 1, further comprising a two-dimensional array of the acousto optic modulators.

6. The system according to claim 1, further comprising matched filters.

7. The system according to claim 1, further comprising a polarizer for linearly polarizing light received by the acousto optic modulators.

8. The system according to claim 1, further comprising an illuminator that illuminates the scene with narrow band light.

9. The system according to claim 8, wherein the illuminator is tunable to scan the scene with light of different colors.

10. An optical detection method, comprising:
collecting light from a scene arriving at different angles with acousto optic modulators; and
detecting the light collected by the acousto optic modulators.

11. The method as claimed in claim 10, wherein the acousto optic modulators are surface acoustic wave modulators.

12. A method as claimed in claim 10, wherein the acousto optic modulators are leaky mode surface acoustic wave modulators.

13. A method as claimed in claim 10, wherein the acousto optic modulators are arranged in an electro-holographic light field detection device including an array of the modulators.

14. The method according to claim 10, further comprising a two-dimensional array of the acousto optic modulators.

15. The method according to claim 10, further comprising matched filters for the acousto optic modulators.

16. The method according to claim 10, further comprising linearly polarizing light received by the acousto optic modulators.

17. The method according to claim 10, further comprising illuminating the scene with narrow band light.

18. The method according to claim 17, wherein the illuminator is tunable to scan the scene with light of different colors.
